(19) United States
(12) Patent Application Publication
(10) Pub. No.: US 2023/0073192 A1
(43) Pub. Date: Mar. 9, 2023

(54) CARBON DIOXIDE RECOVERY DEVICE AND CARBON DIOXIDE RECOVERY SYSTEM USING SAME, AND CARBON DIOXIDE RECOVERY METHOD

(71) Applicant: IHI CORPORATION, Tokyo (JP)

(72) Inventors: Toshiyuki SUDA, Tokyo (JP); Wonyoung CHOI, Tokyo (JP); Takumi ENDO, Tokyo (JP); Kenji TAKANO, Tokyo (JP)

(73) Assignee: IHI CORPORATION, Tokyo (JP)

(21) Appl. No.: 17/986,022

(22) Filed: Nov. 14, 2022

Related U.S. Application Data
(63) Continuation of application No. PCT/JP2021/035483, filed on Sep. 28, 2021.

(30) Foreign Application Priority Data
Oct. 28, 2020 (JP) 2020-180149

(51) Int. Cl. B01D 53/14; B01D 53/62; B01D 53/73; C25B 1/04; C25B 3/09; C25B 11/04; B01D 19/00; C25B 15/08; C10G 2/00; C25B 1/23

(52) U.S. Cl. CPC B01D 53/1475; B01D 19/00; B01D 53/62; B01D 53/73; B01D 53/1425; B01D 53/1493; C10G 2/50; C25B 1/04; C25B 1/23; C25B 3/09; C25B 11/04; C25B 15/081; C25B 15/085; B01D 2252/204; B01D 2257/504; B01D 2258/05

(57) ABSTRACT

Provided is a carbon dioxide recovery device including an absorption part that produces a compound of carbon dioxide and an amine contained in an absorbing solution, and a regeneration part that includes an anode that desorbs the carbon dioxide from the compound to produce a complex compound of the amine, and a cathode that is electrically connected to the anode and regenerates the amine from the complex compound.

### CROSS REFERENCE TO RELATED APPLICATIONS

This application is a continuation application of International Application No. PCT/JP2021/035483, filed on Sep. 28, 2021, which claims priority to Japanese Patent Application No. 2020-180149, filed on Oct. 28, 2020, the entire contents of which are incorporated by reference herein.

### BACKGROUND

### 1. Technical Field

The present disclosure relates to a carbon dioxide recovery device and a carbon dioxide recovery system using the same, and a carbon dioxide recovery method.

### 2. Description of the Related Art

Use of renewable energy such as biomass has been recently promoted, and methane obtained through methane fermentation of biomass is known to be used as an energy source. However, the biogas obtained through methane fermentation contains not only methane but also carbon dioxide, usually in a range of ten to several tens of percent.

Thus, a separation method has been proposed in which carbon dioxide is removed from a gas mixture containing methane and carbon dioxide to produce a gas containing only methane, as described in JP2003-135921A. In this method, only one gas is hydrated and two gases are separated through transition from a first state in which the two gases are not hydrated to a second state in which only one gas is hydrated.

### SUMMARY

JP2003-135921A discloses that methane is extracted from biogas for use as an energy source, but no attention is paid to the carbon dioxide that remains after methane is extracted from biogas. Carbon dioxide has been viewed as a cause of global warming in recent years, and emissions into the atmosphere need to be reduced.

An object of the present disclosure is to provide a carbon dioxide recovery device capable of recovering carbon dioxide with low energy, a carbon dioxide recovery system using the same, and a carbon dioxide recovery method.

A carbon dioxide recovery device according to the present disclosure includes an absorption part that produces a compound of carbon dioxide and an amine contained in an absorbing solution. The carbon dioxide recovery device includes a regeneration part that includes an anode that desorbs the carbon dioxide from the compound to produce a complex compound of the amine, and a cathode that is electrically connected to the anode and regenerates the amine from the complex compound.

The absorption part may produce the compound of carbon dioxide contained in biogas and the amine contained in the absorbing solution. The compound may be a carbamate. The complex compound may be a coordination compound of the compound of the carbon dioxide and the amine, and a metal contained in the anode. The metal may be copper. The regeneration part may include a separator that separates an anode chamber where the anode is arranged from a cathode chamber where the cathode is arranged. The regeneration part may include a gas-liquid separation unit that separates carbon dioxide desorbed at the anode and the absorbing solution containing the complex compound of the amine, the carbon dioxide and the absorbing solution being sent from the anode chamber, and the absorbing solution containing the complex compound of the amine may be sent from the gas-liquid separation unit to the cathode chamber.

A carbon dioxide recovery system according to the present disclosure includes a bioreactor that produces biogas containing methane and carbon dioxide, and the carbon dioxide recovery device.

A carbon dioxide recovery system according to the present disclosure includes the carbon dioxide recovery device, and a reactor that causes a raw material containing carbon dioxide recovered at the carbon dioxide recovery device and containing hydrogen to react.

The carbon dioxide recovery system according to the present disclosure includes the carbon dioxide recovery device, and a co-electrolysis device that co-electrolyzes carbon dioxide recovered at the carbon dioxide recovery device and water to produce carbon monoxide and hydrogen. The carbon dioxide recovery system includes a reactor that causes a raw material containing carbon monoxide and hydrogen produced at the co-electrolysis device to react.

The reactor may produce a hydrocarbon.

A carbon dioxide recovery method includes a step of producing a compound of carbon dioxide and an amine contained in an absorbing solution, a step of desorbing the carbon dioxide from the compound to produce a complex compound of the amine, and a step of regenerating the amine from the complex compound.

The present disclosure makes it possible to provide a carbon dioxide recovery device capable of recovering carbon dioxide with low energy, a carbon dioxide recovery system using the same, and a carbon dioxide recovery method.

### BRIEF DESCRIPTION OF THE DRAWINGS

FIG. 1 is a schematic diagram illustrating a carbon dioxide recovery device according to one embodiment.

FIG. 2 is a schematic diagram illustrating a carbon dioxide recovery system according to one embodiment.

FIG. 3 is a schematic diagram illustrating a carbon dioxide recovery system according to another embodiment.

FIG. 4 is a schematic diagram illustrating an example of an SOEC (solid oxide electrolysis cell) according to the present embodiment.

### DESCRIPTION OF THE EMBODIMENTS

Some exemplary embodiments are described below with reference to the drawings. Note that dimensional ratios in the drawings are exaggerated for convenience of explanation and may differ from the actual ratios.

### Carbon Dioxide Recovery Device

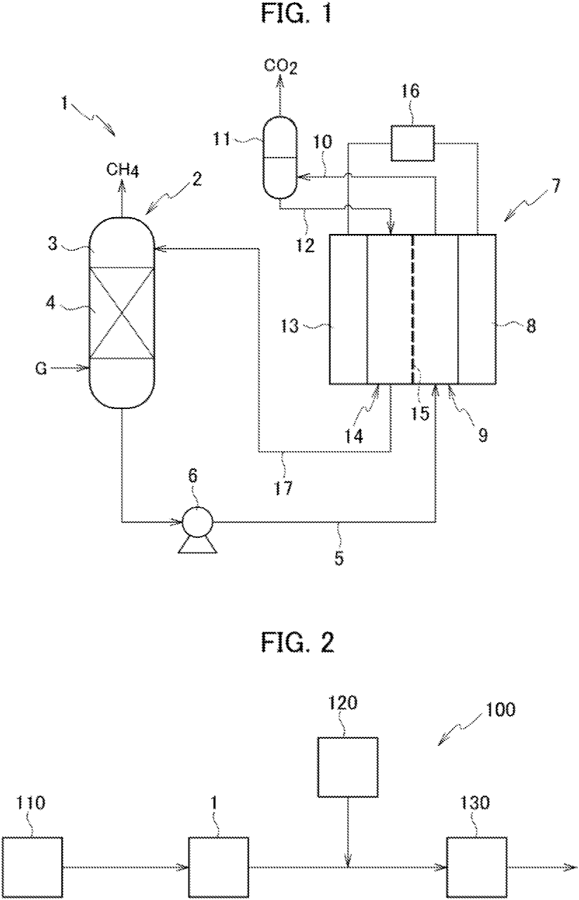

First, a carbon dioxide recovery device 1 according to the present embodiment is described using FIG. 1. The carbon dioxide recovery device 1 recovers carbon dioxide from biogas G. Specifically, the carbon dioxide recovery device 1 generates, from the biogas G containing carbon dioxide to be recovered, a gas having a carbon dioxide concentration higher than that of the biogas G, which is the target of recovery. The carbon dioxide recovery device 1 recovers carbon dioxide from the biogas G and thus generates highly concentrated methane gas. A regeneration part 7 of the carbon dioxide recovery device 1 is a device using an EMAR (electrochemically mediated amine regeneration) method. The carbon dioxide recovery device 1 includes an absorption part 2, supply piping 5, a pump 6, the regeneration part 7, and reflux piping 17.

The absorption part 2 generates a compound of carbon dioxide contained in the biogas G and an amine contained in an absorbing solution. The biogas G is, for example, a gas produced through methane fermentation using biomass as a raw material. The biogas G contains about 60% methane and about 40% carbon dioxide although it varies depending on the raw material and fermentation conditions. Methane is known as a fuel gas for city gas. The absorption part 2 produces a compound of carbon dioxide and an amine and thus removes carbon dioxide from the biogas G, which makes it possible to produce a gas having a higher methane concentration than the biogas G. The production of such a compound enables the absorbing solution that has absorbed carbon dioxide to be easily sent to the regeneration part 7.

The absorbing solution is an amine aqueous solution containing an amine and water, for example. An example of the amine is a polyamine or the like including a diamine, a triamine, and a tetramine. The amine is likely to form a stable complex compound and thus preferably contains at least one amine selected from the group consisting of an ethylenediamine (EDA), an aminoethylethanolamine (AEEA), a diethylenetriamine (DETA), and a triethylenetetramine (TETA). The content of the amine in the absorbing solution can be set appropriately according to the amount of carbon dioxide contained in the biogas G, the processing speed, and the like and is preferably from 10 to 70 mass%.

The compound of carbon dioxide and an amine is not limited as long as carbon dioxide is desorbed through a production of a complex compound in the regeneration part 7, and is a carbamate, for example. A carbamate is a stable compound and carbon dioxide is unlikely to desorb therefrom, and thus it is possible to easily send carbon dioxide as a carbamate from the absorption part 2 to the regeneration part 7.

The absorption part 2 is a countercurrent gas-liquid contact device, for example. The absorption part 2 includes an absorption tank 3 and a filler 4 arranged inside the absorption tank 3. A supply port through which the biogas G is supplied is arranged below the filler 4 in the absorption tank 3. The biogas G supplied from the supply port rises in the absorption tank 3 while coming into gas-liquid contact with the absorbing solution supplied from above the filler 4, and passes through the filler 4, which facilitates the gas-liquid contact with the absorbing solution. The filler 4 is provided to increase the contact area between the supplied gas and the supplied liquid. The filler 4 is made from a ferrous metal material, such as stainless steel or carbon steel, but the material is not limited, and a material having durability and corrosion resistance at processing temperatures and having a shape that is capable of providing the desired contact area can be selected as appropriate.

In the absorbing solution, carbon dioxide and an amine react to form a compound, and carbon dioxide contained in the biogas G is absorbed into the absorbing solution. Carbon dioxide is removed from the biogas G, and a gas containing methane as a main component is discharged from a discharge port arranged above the filler 4 in the absorption tank 3. The gas containing methane as a main component may be used directly as fuel through piping (not shown) or be stored in a storage tank, or the like.

The absorbing solution that has absorbed carbon dioxide drips from the filler 4 to the bottom of the absorption tank 3 and remains in the bottom of the absorption tank 3. The bottom of the absorption tank 3 and an anode chamber 9 of the regeneration part 7 are connected through supply piping 5. The absorbing solution remaining at the bottom of the absorption tank 3 is sent to the regeneration part 7 through the supply piping 5 using the pump 6 arranged in the supply piping 5.

The regeneration part 7 separates carbon dioxide from a rich solution, which is the absorbing solution that has absorbed the carbon dioxide at the absorption part 2, and regenerates the absorbing solution as a lean solution. The regeneration part 7 includes an anode 8, the anode chamber 9, a gas-liquid separation unit 11, a cathode 13, a cathode chamber 14, a separator 15, and a power supply 16.

The anode 8 desorbs carbon dioxide from a compound of carbon dioxide and an amine to form a complex compound of the amine. The complex compound is a coordination compound of a compound of carbon dioxide and an amine, and a metal contained in the anode 8, for example. The metal contained in the anode 8 is not limited as long as it is a metal capable of forming a complex compound with an amine, but it is preferably copper due to easily forming a complex compound with an amine and being easily available. The anode 8 is not limited as long as it is capable of forming a complex compound with an amine and may be a metal mass of the above-described metal, a porous body of the above-described metal, or an object having the above-described metal plated on the surface of a substrate.

The anode 8 is arranged in the anode chamber 9. The absorbing solution containing a compound of carbon dioxide and an amine is sent to the anode chamber 9 from the absorption part 2. When the metal contained in the anode 8 is copper, copper (Cu) forms a coordinate bond with a compound (Am(CO₂)ₘ) of carbon dioxide and an amine in the anode 8, as illustrated in a reaction formula (1) below. Then, a complex compound (CuAm(_{2/m})² ⁺) of an amine and copper is formed and carbon dioxide (CO₂) is desorbed therefrom. Note that in the reaction formula (1), m represents a positive integer.

$$\left(\text{2} / \text{m}\right) \text{Am} {\left({\text{CO}}_{2}\right)}_{\text{m}} \left(\text{aq}\right) + \text{Cu} \left(\text{s}\right) \to {\text{CuAm}}_{\left(\text{2} / \text{m}\right)} {}^{2 +} \left(\text{aq}\right) + 2 {\text{CO}}_{2} \left(\text{g}\right) + 2 {\text{e}}^{-}$$

The gas-liquid separation unit 11 is connected to the anode chamber 9 through piping 10 and to the cathode chamber 14 through piping 12. The gas-liquid separation unit 11 separates the carbon dioxide desorbed at the anode 8 and the absorbing solution containing the complex compound of the amine, which are sent from the anode chamber 9. The absorbing solution containing the complex compound of the amine is sent from the gas-liquid separation unit 11 to the cathode chamber 14. The gas-liquid separation unit 11 is capable of separating the gaseous carbon dioxide from the liquid absorbing solution, and thus it is possible to prevent the carbon dioxide released at the anode 8 from being absorbed again by the absorbing solution. The separated amine-absorbing solution has a larger contact area with the cathode 13 and has a higher reaction efficiency at the cathode 13 because air bubbles are removed at the gas-liquid separation unit 11 and less air bubbles adhere to the cathode 13. It is possible to utilize the separated carbon dioxide as a raw material for, for example, a reactor 130 or a reactor 160, which is described later, or to store the separated carbon dioxide. The gas-liquid separation unit 11 may be a flash tank, for example.

The cathode 13 is arranged in the cathode chamber 14. The absorbing solution containing the complex compound of the amine is sent to the cathode chamber 14 from the anode chamber 9. The cathode 13 is electrically connected to the anode 8 and regenerates the amine from the complex compound. The metal contained in the cathode 13 is not limited but is preferably copper. The cathode 13 is not limited and may be a metal mass of the above-described metal, a porous body of the above-described metal, or an object having the above-described metal plated on the surface of a substrate. In the cathode 13, a complex compound (CuAm(_{2/m})² ⁺) receives an electron, and copper (Cu) of the complex compound precipitates to regenerate the amine (Am), as illustrated in a reaction formula (2) below. Note that in the reaction formula (2), m represents a positive integer.

$${\text{CuAm}}_{\left(2 / \text{m}\right)} {}^{2 +} \left(\text{aq}\right) + 2 {\text{e}}^{-} \to \text{Cu} \left(\text{s}\right) + \left(2 / \text{m}\right) \text{Am} \left(\text{aq}\right)$$

The separator 15 separates the anode chamber 9 from the cathode chamber 14. Thus, the absorbing solution passing through the anode chamber 9 is separated from the absorbing solution passing through the cathode chamber 14 in such a way that they do not mix. The separator 15 is not limited as long as ions are movable between the anode chamber 9 and the cathode chamber 14 and the absorbing solution in the anode chamber 9 and the absorbing solution in the cathode chamber 14 are not mixed. The separator 15 may be at least one of a porous polyolefin membrane or an ion exchange membrane, for example. A porous polyolefin membrane is inexpensive and has excellent physical durability. A porous polyolefin membrane may be coated with a surfactant on the surface thereof to improve wettability. An ion exchange membrane is preferred because it does not require the provision of multiple holes and thus has high separation ability between the absorbing solution in the anode chamber 9 and the absorbing solution in the cathode chamber 14, and also has excellent ion conductivity. The ion exchange membrane may be a cation exchange membrane or an anion exchange membrane, but is preferably a cation exchange membrane.

The power supply 16 is electrically connected to the anode 8 and the cathode 13, and a voltage can be applied between the anode 8 and the cathode 13. The power supply 16 may directly pass a direct current between the anode 8 and the cathode 13, or convert an alternating current into a direct current and pass the direct current between the anode 8 and the cathode 13.

End plates, which are not illustrated, may be arranged on a surface of the anode 8 opposite the separator 15 and on a surface of the cathode 13 opposite the separator 15. The figure illustrates an example in which the regeneration part 7 includes a single cell including the single anode 8 and the single cathode 13, but the regeneration part 7 may include multiple cells. Multiple cells may be stacked in series, or multiple cells may be stacked via common end plates.

The cathode chamber 14 of the regeneration part 7 and the upper part of the absorption tank 3, which is above the filler 4 of the absorption part 2, are connected through the reflux piping 17. The absorbing solution in the cathode chamber 14 of the regeneration part 7 is sent to a part of the absorption part 2, which is above the filler 4, through the reflux piping 17. The absorbing solution is again supplied from above the filler 4 and comes into gas-liquid contact with the biogas G, causing the absorbing solution to absorb carbon dioxide.

As described above, the carbon dioxide recovery device 1 according to the present embodiment includes the absorption part 2 that produces a compound of carbon dioxide and an amine that is contained in an absorbing solution. The carbon dioxide recovery device 1 includes the regeneration part 7 including: the anode 8 that desorbs carbon dioxide from the above-described compound to produce a complex compound of the amine; and the cathode 13 that is electrically connected to the anode 8 to regenerate the amine from the complex compound.

A carbon dioxide recovery method includes a step of producing a compound of carbon dioxide and an amine that is contained in an absorbing solution, a step of desorbing carbon dioxide from the compound to produce a complex compound of the amine, and a step of regenerating the amine from the complex compound.

For example, the biogas G is produced using biomass as a raw material and using microorganisms whose fermentation temperature is around 50 to 60° C. at the highest. Thus, as in a conventional carbon dioxide recovery device, when carbon dioxide contained in a combustion exhaust gas is absorbed by an absorbing solution at 40 to 60° C. in an absorption tower and carbon dioxide is stripped from the absorbing solution at 100° C. or higher in a stripping tower, it is necessary to supply thermal energy to the stripping tower. When there is a boiler capable of supplying thermal energy like in a power plant, it is even possible for a conventional carbon dioxide recovery device to reduce the overall energy efficiency of the system.

However, for example, a biogas is produced at low temperatures as described above. Thus, it is not possible to use the thermal energy of a boiler, and when carbon dioxide of a biogas is recovered by a conventional carbon dioxide recovery device, a dedicated heating device to heat a stripping tower and energy to heat the stripping tower are necessary.

In contrast, the carbon dioxide recovery device 1 according to the present embodiment includes the regeneration part 7 including the anode 8 that desorbs carbon dioxide from a compound of carbon dioxide and an amine to form a complex compound of the amine and the cathode 13 that regenerates the amine from the complex compound. It is thus possible for the anode 8 and the cathode 13 to strip carbon dioxide electrochemically. Therefore, it is possible for the carbon dioxide recovery device 1 according to the present embodiment to recover carbon dioxide contained in the biogas G, for example, at low energy, unlike a conventional carbon dioxide recovery device that strips carbon dioxide using heat.

For example, the regeneration through heating of an amine such as monoethanolamine (MEA) or ethylenediamine (EDA) commonly used in conventional carbon dioxide recovery devices requires an energy of about 40 to 45 kJ/mol CO₂. In contrast, the regeneration of an amine using an EMAR method as in the carbon dioxide recovery device 1 according to the present embodiment requires an energy of about 30 kJ/mol CO₂, assuming a supply gas pressure of 1 bar. Thus, it is possible for the carbon dioxide recovery device 1 according to the present embodiment to regenerate an absorbing solution with about 66 to 75% energy compared to a conventional carbon dioxide recovery device. Therefore, it is possible for the carbon dioxide recovery device 1 and the carbon dioxide recovery method according to the present embodiment to recover carbon dioxide with low energy.

In the carbon dioxide recovery device 1, the compound of carbon dioxide and an amine may be a carbamate. A carbamate is a stable compound and carbon dioxide is difficult to desorb therefrom, and thus it is possible to easily send the carbon dioxide as a carbamate from the absorption part 2 to the regeneration part 7.

In the carbon dioxide recovery device 1, the complex compound may be a coordination compound of a compound of carbon dioxide and an amine, and a metal contained in the anode 8. With the formation of such a complex compound, carbon dioxide is released at the anode 8, which causes the metal contained in the anode 8 to precipitate at the cathode 13, thereby efficiently regenerating the absorbing solution.

The metal contained in the anode 8 may be copper. Copper is likely to form a complex compound with an amine, and a coordination compound of a compound of carbon dioxide and the amine, and copper is likely to be formed at the anode 8. Since copper is easily available, it is possible to form the anode 8 at low cost.

The regeneration part 7 may include the separator 15 that separates the anode chamber 9 where the anode 8 is arranged from the cathode chamber 14 where the cathode 13 is arranged. It is possible for the separator 15 to separate the absorbing solution passing through the anode chamber 9 from the absorbing solution passing through the cathode chamber 14 in such a way that they do not mix. Thus, it is possible to prevent carbon dioxide released at the anode 8 from being absorbed again by the absorbing solution.

The regeneration part 7 includes the gas-liquid separation unit 11 that separates the carbon dioxide desorbed at the anode 8 and the absorbing solution containing the complex compound of the amine, which are sent from the anode chamber 9, and the absorbing solution containing the complex compound of the amine may be sent from the gas-liquid separation unit 11 to the cathode chamber 14. The gas-liquid separation unit 11 is capable of separating the gaseous carbon dioxide from the liquid absorbing solution, and thus it is possible to prevent the carbon dioxide released at the anode 8 from being absorbed again by the absorbing solution. The separated amine-absorbing solution has a larger contact area with the cathode 13 and has a higher reaction efficiency at the cathode 13 because air bubbles are removed at the gas-liquid separation unit 11 and less air bubbles adhere to the cathode 13.

### Carbon Dioxide Recovery System

### First Embodiment

Next, a carbon dioxide recovery system 100 according to the present embodiment is described with reference to FIG. 2. The carbon dioxide recovery system 100 according to the present embodiment includes a bioreactor 110, the carbon dioxide recovery device 1 described above, a water electrolysis device 120, and the reactor 130.

The bioreactor 110 generates biogas including methane and carbon dioxide. Biogas can be produced using biomass as a raw material. Biomass is a resource derived from plants and animals, and by using such renewable energy instead of fossil resources, it is possible to curb carbon dioxide emissions, which are viewed as a cause of global warming. Biomass includes wood, herbs, paper, livestock waste, domestic wastewater such as sewage sludge and septic tank sludge, and organic matter such as food waste, for example. The bioreactor 110 is installed in, for example, a beverage factory, a sewage treatment plant, and the like. To efficiently produce biogas, biomass having undergone a pre-treatment, such as grinding and diluting of the feedstock and removal of foreign matter in the feedstock, may be supplied to the bioreactor 110, as necessary.

The bioreactor 110 may be a batch type in which the supply, fermentation, and discharge of raw materials are repeated as a unit, or may be a continuous type in which the supply, fermentation, and discharge of raw materials are continuously and simultaneously performed. The bioreactor 110 may include a fermenter for performing methane fermentation treatment. The bioreactor 110 may contain only a single fermenter or multiple fermenters. The bioreactor 110 may include a heating unit that raises the temperature of the fermenter to a predetermined temperature in such a way that the fermentation temperature is optimal.

The fermenter may hold a microorganism to perform methane fermentation. The microorganism holding method is not limited, but examples thereof include a fixed bed method, a fluidized bed method, and a UASB (upflow anaerobic sludge blanket) method. In the fixed bed method, a carrier carrying a microorganism is usually filled into a fermenter. In the fluidized bed method, a carrier carrying a microorganism is usually housed in a fermenter and flows in the fermenter. In the UASB method, a microorganism is usually not carried on a carrier, and granules that are an aggregate of the microorganism are housed in a fermenter. The particle size of the granules is about 0.5 to 2 mm, for example.

In methane fermentation, methane is produced from biomass using many anaerobic microorganisms. Specifically, organic matter including a protein, a carbohydrate, and a lipid is hydrolyzed to produce an amino acid, a sugar, and a fatty acid. An amino acid, a sugar, and a fatty acid are decomposed into an acetic acid, carbon dioxide, and hydrogen. Methane is then produced from the acetic acid, carbon dioxide, and hydrogen using a methanogen. The bioreactor 110 produces biogas, and the biogas includes carbon dioxide as well as methane.

A methanogen may contain a thermophilic methanogen, which is active at high temperatures, such as 50 to 60° C., or a mesophilic methanogen, which is active at moderate temperatures, such as 35 to 38° C. When a thermophilic methanogen is used, it is possible to shorten the methane fermentation time. When a low-temperature methanogen is used, it is possible to lower the temperature necessary to heat a fermenter.

In addition to methane and carbon dioxide, biogas may contain impurities, such as a sulfur component including hydrogen sulfide and methyl mercaptan, organic polysiloxane, and ammonia, depending on the components contained in the raw biomass. Thus, the above-described impurities may be removed to prevent the adhesion of impurities to the carbon dioxide recovery device 1 and the piping.

The water electrolysis device 120 electrolyzes water to produce hydrogen. The water electrolysis device 120 is not limited as long as it is possible to electrolyze water to produce hydrogen. For example, the water electrolysis device 120 may include an alkaline electrolytic cell, a solid polymer electrolytic cell, or an SOEC (solid oxide electrolytic cell).

The reactor 130 causes a raw material containing carbon dioxide recovered at the carbon dioxide recovery device 1 and containing hydrogen to react. The hydrogen supplied to the reactor 130 may be hydrogen produced in the water electrolysis device 120. The carbon dioxide recovery device 1 is capable of electrochemically regenerating the absorbing solution and easily adjusting the loads of the carbon dioxide recovery and the water electrolysis, and thus it is possible to improve the controllability of the entire carbon dioxide recovery system 100. It is possible for the reactor 130 to produce a product that can be produced by causing a raw material containing carbon dioxide and containing hydrogen to react. The reactor 130 preferably produces a hydrocarbon because a hydrocarbon is usable as an energy source and a raw material for chemicals, and thus has high utility value.

A hydrocarbon includes at least one of a paraffin or an olefin, for example. A paraffin means an alkane, and an olefin means an alkene. These hydrocarbons can be produced through a Fischer-Tropsch process. Preferably, at least one of the paraffin or olefin contains a hydrocarbon having a carbon number of 1 to 4. Examples of the paraffin having a carbon number of 1 to 4 include methane, ethane, propane, and butane. Examples of the olefin having a carbon number of 2 to 4 include ethylene, propylene, 1-butene, 2-butene, isobutene, and 1,3-butadiene. Note that among these, methane, ethane, and propane are usable as fuel for city gas. An olefin having a carbon number of 2 to 4 is useful because it is usable also as a raw material for plastics. Note that the exhaust gas discharged from the reactor 130 may contain a compound other than those described above.

For the reactor 130, a known reactor is usable, such as a shell-and-tube reactor, a plate reactor, or a fluidized bed reactor, for example. The shell-and-tube reactor is inexpensive because of its simple structure and is capable of easily dealing with an increase in capacity by increasing the number of tubes. In contrast, the flat-plate reactor has a high heat exchange efficiency and thus is superior in removing heat of reaction and improving reaction efficiency.

The reactor 130 has a catalyst arranged in a flow path thereof through which a raw material passes, and it is possible to produce a hydrocarbon when the raw material comes into contact with the catalyst. The catalyst arranged in the reactor 130 is not limited as long as it is possible to produce a hydrocarbon from a raw material. The catalyst is selected in terms of the type of hydrocarbon to be produced, and a known catalyst, such as an iron catalyst or a cobalt catalyst, is usable. It is possible to mainly produce a light hydrocarbon in the case of an iron catalyst, and it is possible to mainly produce a heavy hydrocarbon, including wax, in the case of a cobalt catalyst. In the case of an iron catalyst, it is possible to mainly produce an olefin and a paraffin, and in the case of a cobalt catalyst, it is possible to mainly produce a paraffin. Note that the iron catalyst contains iron as an active component, and the cobalt catalyst contains cobalt as an active component. The content of the active component is preferably 20 mass% or more of the total catalyst. The iron catalyst preferably produces a hydrocarbon having a carbon number of 2 or more. This makes it possible to produce a light olefin (lower olefin), which is also used as a raw material for plastics. Reaction conditions in the reactor 130 are not limited, but for example, the reaction temperature is 200 to 400° C., and the pressure is 0.1 to 2 MPa.

As described above, the carbon dioxide recovery system 100 according to the present embodiment may include the bioreactor 110 that generates biogas containing methane and carbon dioxide, and the carbon dioxide recovery device 1. As described above, it is possible for the carbon dioxide recovery device 1 to recover carbon dioxide contained in biogas at low energy without having a heat source. Thus, it is possible for even businesses that do not have large heat sources, such as beverage factories and sewage treatment plants, to recover carbon dioxide from the biogas produced at the bioreactor 110 with low energy.

The carbon dioxide recovery system 100 may include the carbon dioxide recovery device 1 and the reactor 130 that causes a raw material containing carbon dioxide recovered at the carbon dioxide recovery device 1 and containing hydrogen to react. When the carbon dioxide recovery system 100 includes the above-described reactor 130, it is possible to convert the carbon dioxide recovered at the carbon dioxide recovery device 1 into valuables, and thus to utilize the carbon dioxide in an effective manner.

### Second Embodiment

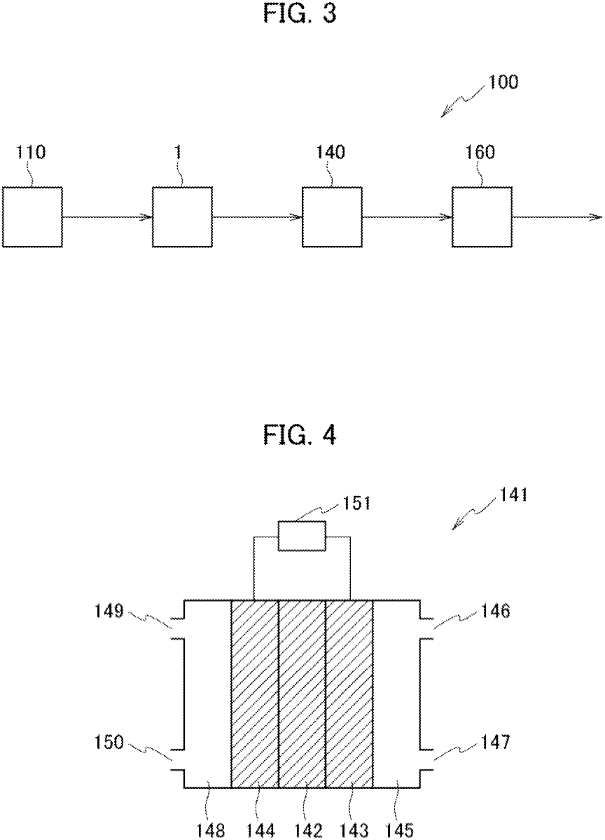

Next, the carbon dioxide recovery system 100 according to the present embodiment is described with reference to FIG. 3. The carbon dioxide recovery system 100 according to the present embodiment includes the bioreactor 110 described above, the carbon dioxide recovery device 1 described above, a co-electrolysis device 140, and the reactor 160.

The co-electrolysis device 140 co-electrolyzes carbon dioxide recovered at the carbon dioxide recovery device 1 and water to produce carbon monoxide and hydrogen. As shown in FIG. 4, the co-electrolysis device 140 includes an SOEC 141, for example. The co-electrolysis device 140 may include a single SOEC 141 or a cell stack in which multiple SOECs 141 are stacked.

The SOEC 141 includes an electrolyte layer 142, a hydrogen electrode 143 arranged on one side of the electrolyte layer 142, and an oxygen electrode 144 arranged on the other side of the electrolyte layer 142. A hydrogen electrode side channel 145 is arranged on the side of the hydrogen electrode 143 opposite the electrolyte layer 142, and a hydrogen electrode side channel inlet 146 and a hydrogen electrode side channel outlet 147 are arranged in the hydrogen electrode side channel 145. An oxygen electrode side channel 148 is arranged on the side of the oxygen electrode 144 opposite the electrolyte layer 142, and an oxygen electrode side channel inlet 149 and an oxygen electrode side channel outlet 150 are provided in the oxygen electrode side channel 148. A voltage application unit 151 is electrically connected to the hydrogen electrode 143 and the oxygen electrode 144, and a voltage is applied between the hydrogen electrode 143 and the oxygen electrode 144 by the voltage application unit 151.

The electrolyte layer 142 contains a solid oxide having oxide ion conductivity, such as YSZ (yttria-stabilized zirconia), for example. The hydrogen electrode 143 contains at least one of Ni or an Ni compound, such as NiO, for example. The oxygen electrode 144 contains an oxide exhibiting electronic conductivity, such as LSM ((La, Sr)MnO₃), LSC((La, Sr)CoO₃), or LSCF((La, Sr)(Co, Fe) O₃).

In the co-electrolysis device 140, water vapor and carbon dioxide are supplied from the hydrogen electrode side channel inlet 146 to the hydrogen electrode side channel 145, and hydrogen and carbon monoxide are generated from the water vapor and carbon dioxide, respectively, at the hydrogen electrode 143. The produced hydrogen and carbon monoxide are discharged from the hydrogen electrode side channel outlet 147. Oxygen ions generated at the hydrogen electrode 143 move through the electrolyte layer 142 to the oxygen electrode 144, and oxygen is generated at the oxygen electrode 144. A sweep gas is supplied from the oxygen electrode side channel inlet 149 to the oxygen electrode side channel 148. Oxygen generated at the oxygen electrode 144 is discharged with the sweep gas from the oxygen electrode side channel outlet 150.

The reactor 160 causes a raw material containing carbon monoxide and hydrogen produced at the co-electrolysis device 140 to react. The hydrogen supplied to the reactor 160 may be hydrogen produced at the water electrolysis device 120. It is possible for the reactor 160 to produce a product that can be produced by reacting a raw material that contains carbon monoxide and hydrogen. Similarly to the reactor 130, the reactor 160 preferably produces a hydrocarbon because a hydrocarbon is usable as an energy source and a raw material for chemicals, and thus has high utility value. For the reactor 160, one similar to the reactor 130 is usable.

As described above, the carbon dioxide recovery system 100 according to the present embodiment includes the carbon dioxide recovery device 1 and the co-electrolysis device 140 that co-electrolyzes carbon dioxide recovered at the carbon dioxide recovery device 1 and water to produce carbon monoxide and hydrogen. The carbon dioxide recovery system 100 includes the reactor 160 that causes a raw material containing carbon monoxide and hydrogen produced at the co-electrolysis device 140 to react. When the carbon dioxide recovery system 100 includes the above-described reactor 160, it is possible to convert the carbon dioxide recovered at the carbon dioxide recovery system 1 into valuables, and thus to utilize the carbon dioxide in an effective manner. The carbon dioxide recovery device 1 is capable of electrochemically regenerating the absorbing solution and easily adjusting the loads of the carbon dioxide recovery and the co-electrolysis, and thus it is possible to improve the controllability of the entire carbon dioxide recovery system 100.

Although not limited, renewable energy, such as solar, wind, and hydraulic power, may be used as electric energy for the power supply 16 of the carbon dioxide recovery device 1, the electrolysis of the water electrolysis device 120, and the electrolysis of the co-electrolysis device 140. Using such renewable energy makes it possible to further reduce the amount of carbon dioxide emissions in the entire system.

Although some embodiments have been described, it is possible to modify or alter the embodiments based on the above disclosure. All the components of the above-described embodiments and all the features described in the claims may be individually extracted and combined as long as they do not contradict each other.

What is claimed is:

1. A carbon dioxide recovery device, comprising:
an absorption part that produces a compound of carbon dioxide and an amine contained in an absorbing solution; and
a regeneration part that includes an anode that desorbs the carbon dioxide from the compound to produce a complex compound of the amine, and a cathode that is electrically connected to the anode and regenerates the amine from the complex compound.

2. The carbon dioxide recovery device according to claim 1, wherein
the absorption part produces the compound of carbon dioxide contained in biogas and the amine contained in the absorbing solution.

3. The carbon dioxide recovery device according to claim 1, wherein the compound is a carbamate.

4. The carbon dioxide recovery device according to claim 1, wherein
the complex compound is a coordination compound of the compound of the carbon dioxide and the amine, and a metal contained in the anode.

5. The carbon dioxide recovery device according to claim 4, wherein the metal is copper.

6. The carbon dioxide recovery device according to claim 1, wherein
the regeneration part includes a separator that separates an anode chamber where the anode is arranged from a cathode chamber where the cathode is arranged.

7. The carbon dioxide recovery device according to claim 6, wherein
the regeneration part includes a gas-liquid separation unit that separates carbon dioxide desorbed at the anode and the absorbing solution containing the complex compound of the amine, the carbon dioxide and the absorbing solution being sent from the anode chamber, and
the absorbing solution containing the complex compound of the amine is sent from the gas-liquid separation unit to the cathode chamber.

8. A carbon dioxide recovery system, comprising:
a bioreactor that produces biogas containing methane and carbon dioxide; and
the carbon dioxide recovery device according to claim 2.

9. A carbon dioxide recovery system, comprising:
the carbon dioxide recovery device according to claim 1; and
a reactor that causes a raw material containing carbon dioxide recovered at the carbon dioxide recovery device and containing hydrogen to react.

10. A carbon dioxide recovery system, comprising:
the carbon dioxide recovery device according to claim 1;
a co-electrolysis device that co-electrolyzes carbon dioxide recovered at the carbon dioxide recovery device and water to produce carbon monoxide and hydrogen; and
a reactor that causes a raw material containing carbon monoxide and hydrogen produced at the co-electrolysis device to react.

11. The carbon dioxide recovery system according to claim 9, wherein the reactor produces a hydrocarbon.

12. A carbon dioxide recovery method, comprising:
a step of producing a compound of carbon dioxide and an amine contained in an absorbing solution;
a step of desorbing the carbon dioxide from the compound to produce a complex compound of the amine; and
a step of regenerating the amine from the complex compound.
